(19) United States
(12) Patent Application Publication
(10) Pub. No.: US 2011/0025685 A1
(43) Pub. Date: Feb. 3, 2011

(54) COMBINED GEOMETRIC AND SHAPE FROM SHADING CAPTURE

(76) Inventor: Doug Epps, Kentfield, CA (US)

Correspondence Address: DISNEY ENTERPRISES, INC.;C/O TOWNSEND AND TOWNSEND AND CREW LLP, TWO EMBARCADERO CENTER, 8TH FLOOR, SAN FRANCISCO, CA, 94111-3834, US

(21) Appl. No.: 12/511,926

(22) Filed: Jul. 29, 2009

(51) Int. Cl. G06T 15/00; G06K 9/00

(52) U.S. Cl. 345/419; 382/118

(57) ABSTRACT

An image capturing system includes one or more image capturing devices and one or more illumination sources that have known and fixed positions relative to one another, wherein the illumination source is held constant or can be calibrated to provide a known illumination level on a subject, such that the variation in shading at various points on the surface of the subject, with different orientations relative to the illumination source, can be used to determine the orientation of the surface of the subject and thereby used to more accurately render an image or other representation of the subject.

### BACKGROUND OF THE INVENTION

The present invention relates to computer aided image rendering. More specifically, embodiments of the present invention relate to accurate rendition of the surfaces of a subject object using constant and known illumination in an image capturing system.

Presently, the use of motion capture, motion tracking, or “mocap” for translating the movement of a subject into a digital model is limited to tracking the movement of a subject. In almost all current techniques of motion capture modeling or animation, markers are applied to the surface of the subject. In some cases this means the markers are applied to skin or clothing of an actor at a finite number of locations. Multiple frames are then captured over time to capture the movement of the markers. The movement of the markers are recorded or analyzed at an exposure or sensitivity level that limits detection to the location of the markers in the images. Using various known algorithms, the markers are isolated and tracked in the captured images so that their location in the frame over time can be translated into a rendered still image or series of images to create a moving picture.

A number of different types of markers, each with well known drawbacks, are typically used in motion capture systems. Types of markers currently used include passive optical markers, active optical markers and time modulated active markers.

Passive optical markers are typically brightly colored or highly reflective discs or spheres that are applied to the surface of the subject. The lighting, the sensitivity of the camera, or both are controlled to isolate the light reflected from the markers from the subject and the background when images are captured. Typically, passive optical markers are either spheres or discs. FIG. 1A illustrates one such system 100 and the drawbacks in the prior art.

In FIG. 1A, markers 150 are attached to subject object 160 at various locations. The locations can vary depending on the shape of the subject and the intended motion to be captured. In this specific example, subject object 160 is a hemispherical object with a flexible skin that can move in three dimensions. Subject object 160 is shown from head-on and in profile.

Typically, camera 110 is configured with an on-axis illumination source such as an on-axis ring light 120. The illumination rays 130 emitted from ring light 120 are typically collimated or controlled to illuminate a constrained solid angle. Light incident on the markers is reflected back to the camera 110 for multiple frames and the movement of each marker between frames is tracked by the computer system in computer system and display 460. An image or a series of images can be rendered in response to the tracked motion of markers 150.

The drawback of systems such as system 1000 is that the information gathered is only two-dimensional. No information regarding the orientation of the surface of subject 155 is captured for rendering of the surface the subject. To complete the rendering of the surface, many presumptions must be made regarding the manner in which the surface of the subject will deform based on the motion of the markers and the nature of the subject. Alternatively, the deformations can be controlled through time intensive and expensive manual adjustments. The results of either solution for determining the deformations of the surface can cause unnatural looking renderings when using passive optical markers.

Other types of markers used such as active optical markers and semi-passive optical markers have, in addition to the limitations discussed above, the drawback of requiring powered visible or invisible light emitters to be applied to the surface of the subject. Such systems that use powered light emitters, while useful for rendering images based on images captured in conditions where the lighting and exposure are less controllable, are difficult to apply to the skin of an actor and are therefore not as useful for capturing facial performance data, such as facial expressions of an actor or other minute deformations of an object.

Similarly, modulated active markers are typically emitters that are pulsed or have their amplitude modulated over time to provide marker identification not only have the draw back of complicated wiring and application to the subject, but also require complicated control circuitry and software to control the modulation. Therefore, motion capture systems that use modulated active markers are expensive and complicated to operate and not practical for capturing facial performance data and the like.

Accordingly, there is a need are methods and apparatus that address the problems discussed above.

### BRIEF SUMMARY OF THE INVENTION

The present invention relates to computer aided image rendering. More specifically, embodiments of the present invention relate to accurate rendition of the surfaces of a subject using constant and known illumination in an image capturing system.

Embodiments of the present invention include an image capturing system for rendering the surface of a subject object into digital image. Such an image capturing system further includes one or more image capturing devices and one or illumination sources. The image capturing devices and the illumination sources all have known geometric reference data. The illumination sources have known illumination output or can be controlled to provide a calibrated illumination output. In some embodiments of the present invention, geometric reference data includes the position and orientation of each image capturing device and illumination source relative to one another and relative to a subject object for each frame of performance data of the subject object captured by the image capturing system. In various embodiments, the geometric reference data also includes the illumination output of the illumination source.

In various embodiments of the present invention, the illumination provided by the illumination source will fall off as the direction normal to the surface of the subject object goes more perpendicular to the direction of the incident illumination. Areas on the surface of the subject object that are illuminated by glancing incident illuminations will appear darker than areas on the surface of the subject object that are illuminated by incident illumination parallel to the direction normal to the surface of the subject object. In various embodiments, the difference in illumination will appear as shading in the performance data of the subject object. In various embodiments, the correlation of the shading to the direction normal to the surface, or surface normals, of the subject object is determined. In some embodiments, the correlation of the shading to the surface normals are determined and stored in a data store before the performance data is captured. In other embodiments, the correlation of the shading to the surface normals is determined in real time or in process. In some embodiments, the correlation between shading and surface normals of the subject object takes into account the nature of the surface of the subject object.

In various embodiments, in response to the performance data and the correlation between shading and the surface normals, a surface or line is fit to a number of captured locations on the subject objects surface to render an image based on the captured performance data of the subject object. In such embodiments, the fit of the surface or the line in the rendered image can be constrained by the direction of the surface normal at each location to provide a more accurate rendering of the surface of the subject object.

In various embodiments, the image capturing device is a digital still or motion camera. In various embodiments, the illumination source is a point source such that the illumination that it provides is uniform in all directions at any given distance from the illumination source.

In various other embodiments of the present invention, a matte surface is applied to the surface of the subject object to provide a diffuse reflective surface and prevent specular reflections from interfering with capturing performance data. In some embodiments, the matte surface is applied in the form of a matte make-up or paint. In other embodiments, the matte surface is applied as discrete sections or discs.

In various embodiments, the image capturing system is attached to a head gear. Such devices are particularly useful for capturing facial performance data for the surface of the head of an actor. In such devices, one or more image capturing devices and one or more illumination sources are attached to arms that are attached to the head gear that can be worn on the head of an actor. In various embodiments, the head gear is securely fastened to the head of an actor, and the arms extend to hold the image capturing devices and illumination sources over the areas of interest of the actor's head. In some embodiments, the arms are rigidly held in place over the surface of the actors head. In other embodiments, the arms are adjustable so that the device can be customized to capture the facial performance data of a particular actor and area of interest. In yet other embodiments, the arms can be controlled remotely to change position over the surface of the subject actor's face during capture of the performance data. In such embodiments, the geometric reference data and the correlation and between the shading captured in the performance data to the surface normals of the surface of the subject must be determined dynamically. Alternatively, the geometric reference data and correlation between shading and surface normals can be determined in advance for a set number of predetermined positions of the arms, and the correlation can be interpolated for any position in between.

Various embodiments of the present invention may utilize illumination sources that have wavelengths outside of the range of human visible wavelengths. In such embodiments, the illumination source can positioned in the field of view of an actor without distracting or interfering with the vision of the actor. As examples, the illumination sources may have a wavelengths in the infrared or ultra violet. In such embodiments, each image capturing devices may be configured to selectively detect only the wavelengths of illumination emitted by the corresponding illumination source. This can be achieved by selecting an appropriate optical filter or an appropriate sensor to limit sensitivity to the desired wavelengths.

In other embodiments of the present invention, a computer system and display are provided to communicate or control the image capturing system. In other embodiments, the computer system includes a data store to store the correlation data for the correlation between shading and surface normals of the surface of objects or actors. The correlation data can then be called by the computer system when a particular actor or object is indicated as the subject object. From the correlation data and the performance data including shading data, surface normals for an arbitrary number of locations on the object can be determined. In various embodiments, the surface normals for and arbitrary number of location on the surface of an object, the performance data and the nature of the object can be used to provide the geometric shape data of the subject object that can be used in rendering a image of the subject object.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings.

FIG. 1A is an illustration of a typical motion capture system found in the prior art;

FIG. 1B is an overview of an embodiment of the present invention;

FIG. 2 is a flow chart of a method according to one embodiment of the present invention;

FIG. 3A-B illustrate subjects, the rendering of which can be improved by embodiments of the present invention.

FIG. 4A-B illustrate the advantages of the present invention over the prior art in rendering images.

FIG. 5 illustrates an image capturing system according to one embodiment of the present invention.

FIG. 6 a block diagram of typical computer system according to an embodiment of the present invention.

### DETAILED DESCRIPTION OF THE INVENTION

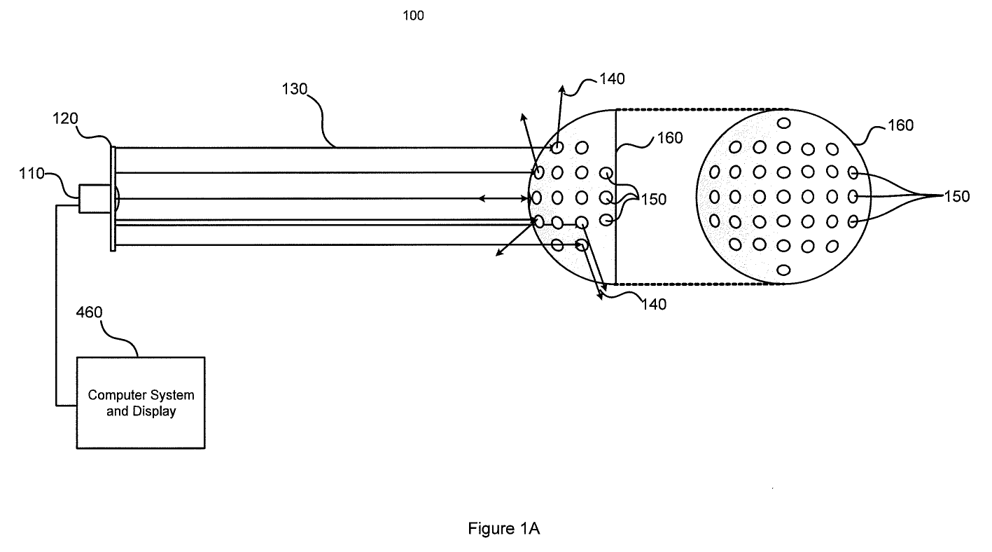

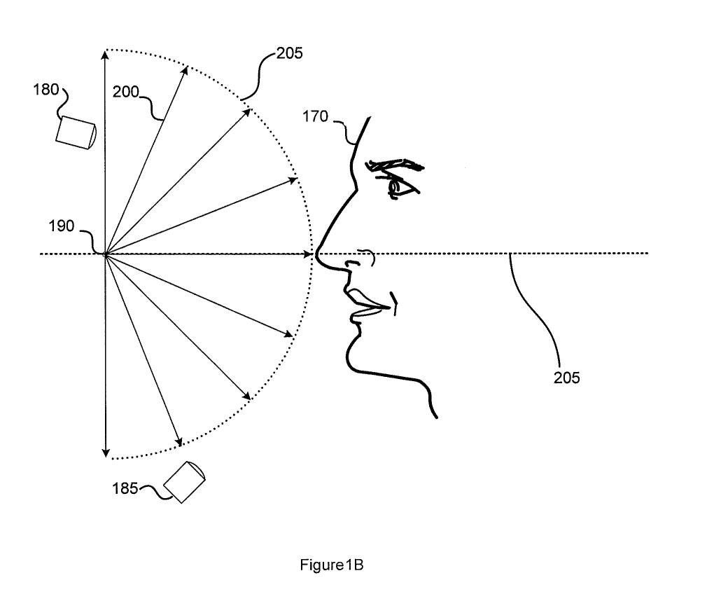

FIG. 1B is overview of one embodiment of the present invention. The image capturing system depicted in FIG. 1B includes illumination source 190, image capturing device 180, image capturing device 185 used to capture performance data of subject object 170. Image capturing devices 180 and 185 can be any suitable devices including, but not limited to, digital video cameras, digital still cameras, film motion cameras, still film cameras and the like. Image capturing devices 180 and 185 can be connected to a computer system not shown in FIG. 1B. In the case that image capturing devices are film based cameras, the images can be scanned or otherwise input into a computer system for processing after images are captured.

Subject 170 can be any three-dimensional object with a surface that is either static or dynamic over time. For example, subject 170 can be a flexible membrane or the skin on the face of an actor that is deformed or moved such that the direction normal to the surface of subject 170 changes relative to the optical axes of image capturing devices 180 and 185 and the direction of the incident illumination provided by illumination source 190.

The geometric reference data of image capturing devices 180 and 185 and illumination source 190 relative to subject 170 is known. As used herein, geometric reference data refers to information regarding the relative positions and angles of illumination of illumination source 190 to image capturing devices 180 and 185 as well as to subject 170. In some embodiments, the geometric reference data can include the illumination output of illumination source 190. The illumination output of illumination source 190 can be a known constant or can calibrated to provide a desired known output depending on the scene and the nature of the subject 170.

For example, image capturing devices 180 and 185 are fixed relative to illumination source 190 such that for any given image or frame captured by image capturing devices 180 or 185, the direction of the illumination incident upon subject 170 can be determined. In some embodiments, illumination source 190 is a point source, such that the illumination provided is uniform in all directions at any given distance 205. However, other variations of illumination sources can be used. For example, a light source with a uniform cone of light within a define cone angle can be used when appropriate for certain subjects when practical. One example of such a subject is a small region on a human face such as the area around an eye.

In some embodiments either or both image capturing devices 180 or 185 can used at any given time. Depending on the shape and characteristics of the subject 170 and the level detail desired for the finished rendered image, two or more image capturing devices maybe used simultaneously. When a subject 170 has multiple facets or has a complex surface, more cameras can be used to capture images from various angles and thus capture more performance data of the subject. Similarly, two or more illumination sources can be used to illuminate subject 170 from difference angles. In such embodiments, the geometric reference data for all image capturing devices and illumination sources can be determined so that is can be used later to determine the direction of illumination for any given frame captured. Furthermore, it is desirable to have one illumination source for each image capturing device.

Performance data, as used herein, refers to the recorded movement of a subject object in time and space. In particular, according to various embodiments of the present invention, the movement of an arbitrary number of locations on the surface of the subject can be tracked over time in the performance data. Such movement can include the deformation or a change in orientation of the surface of the subject object even if the location of the surface does not necessarily move in space over time. For example, the surface at a location on a subject can change orientation in space without a perceptible change in space. This typically occurs when a surface tilts around a point or a line. In various embodiments, performance data refers to image data of the subject 170 as it illuminated by illumination source 190. As the surface of subject 170 moves or is deformed, the illumination on the surface of subject 170 from illumination source 190 changes. The changes in the illumination on the surface of the subject 170 appears as shading on the object surfaces in the captured images. In various embodiments, the images of the shading is recorded as shading data and can be included in the performance data. Performance data can include single images or a series of frames used to compile a moving picture.

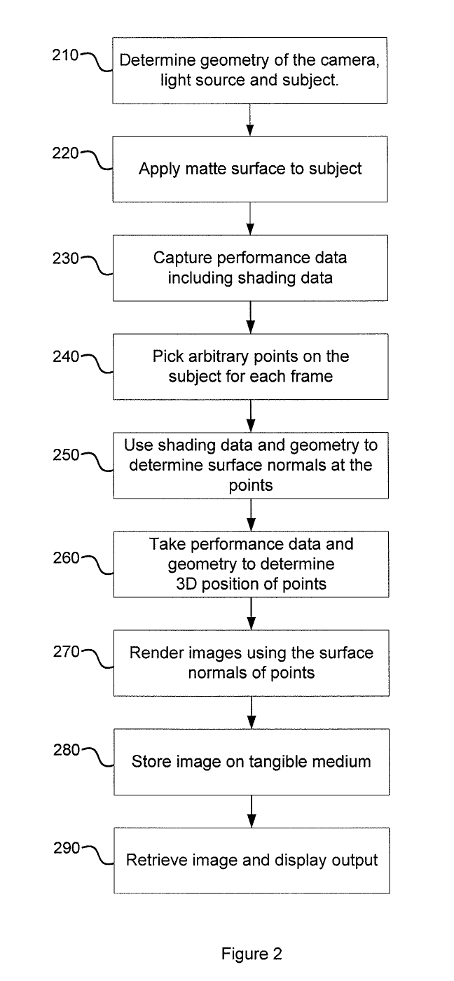

FIG. 2 depicts a flow diagram for a method for rendering images based on performance data of a subject according to one embodiment of the present invention. In step 210, the geometric reference data of the image capturing system is determined. Step 210 can include taking physical measurements of the image capturing devices 180 and 185 relative to illumination source 190. As previously discussed, two or more illumination sources and two or more image capturing devices can be used, and in such an embodiment it is desirable to know the geometric reference data for all components in the image capturing system relative to one another. One skilled in the art will realize that the geometric reference data can be collected and stored in various useful coordinate systems and not deviate from the spirit of the present invention.

In various embodiments, it is possible to equip all light sources, capturing devices, subject and other components with tracking devices that register the location of the corresponding component so that the location of each component is recorded and stored for each frame or image captured. In this way, the relative positions of all components can be determined with the location data stored for each frame. In another embodiment, the location data for each component of the image capturing system can be either physically or electronically stamped or stored for each frame or image captured. In such embodiments, the components of the image capturing system and the subject do not have to remain static and instead can be moved dynamically between frames or images captures.

In step 220, a matte surface or surfaces are applied to the surface of the subject 170 to provide a diffuse reflective surface or surfaces for the illumination from illumination source 190 off which to reflect. In one embodiment, the matte surface is applied in the form of a matte make-up or paint. The advantages of the matte make-up or paint are at least two fold: (1) Most of, if not all of, the surface of the subject 170 can be coated so as to provide a multitude of potential sampling locations, and (2) possible specular reflections off of the surface of the subject 170 are prevented from interfering with detecting the gradient of illumination that varies with the orientation of the surface of the subject when illuminated by the illumination source. In various embodiments, a matte surface in the form of make-up or paint can be formulated to reflect preferentially a specific wavelength or band of wavelengths. In various embodiments the matte surface can be in the form pieces of planar material that can be applied to the surface of the subject 170. Such an embodiment has the advantage of providing a planar surface at a particular point for any given surface. That is, for a given point of application, the planar surface gives more illumination data than say a single point and emphasizes the change of the direction perpendicular to the surface of the surface of the subject.

In various embodiments, once the geometric reference data is determined and the matte surface is applied to the subject 170, the illumination source 190 is turned on and performance data is captured by image capturing device 180 and 185. In various embodiments, the performance data includes shading data. As used herein, shading data is data regarding the location and amount of light that is reflected off the surface of the subject back to image an capturing device. For example, as depicted in FIG. 1B, subject 170 is illustrated as it might appear when illuminated by illumination source 190 that is on axis 207. In various embodiments, the shading data includes the illumination pattern when viewed on axis 207 with the apex of subject 170. In other embodiments, subject 170 can be view from one or more angles not on axis 207.

As can be seen in FIG. 1B, the region immediately around the apex of subject 170, with the direction perpendicular to the surface of subject 170 closest to axis 207 is the brightest. As the surface of subject 170 curves away from illumination source 190, the illumination gets dimmer. One skilled in the art will realize that the fall off in illumination is directly related to the direction perpendicular to the surface at any given point on subject 170. The more parallel the direction perpendicular to the surface subject 170 is to the incident illumination, the more illumination subject 170 will reflect and appear to be illuminated. The hemispherical nature of subject 170 is only one example of a shape of a subject. In practice, the surface of subject 170 can be any shape and configuration.

In various embodiments, once performance data including shading data is captured, a number of arbitrary points on the subject are selected in step 240. In some embodiments, the points are selected by a user. In other embodiments, the points are selected automatically by a program executed on a computer system. In various embodiments, the points on the subject are chosen arbitrarily for each frame captured, thus allowing for customized analysis of each frame to determine the direction perpendicular or normal to the surface of the subject.

In various embodiments, in step 250, based on the performance data including shading data and geometric reference data of the image capturing system, the direction perpendicular to the surface of the subject is determined at the points selected in step 240. In some embodiments, the direction perpendicular to the surface of the subject will be determined based on the geometric reference data of the image capturing system including two or more image capturing devices at a set of arbitrary points for each frame captured.

In step 260, the multi-dimensional position in space of the points selected in step 240 is determined based on the performance data and the geometric reference data. In various embodiments, the determination of the multi-dimensional position in space of the points is enhanced with the performance data including the shading data.

In some embodiments of the present invention, the determination of the multi-dimensional position in space of the points is enhanced by determining the direction normal to the surface of the subject. The direction normal to the surface of the subject at a particular location or point is also, herein, referred to as a surface normal at that particular location or point. To determine the direction normal to the surface of a subject of any given point, a correlation between the position of a point on the surface of the subject relative to the image capturing device and illumination source and the shading data captured can be determined. In some embodiments the correlation between the positions of a point on the surface of the subject relative the image capturing device and the illumination source and the shading data is determined prior to capturing the performance data. In such embodiments, the subject can take other positions and orientations anticipated for a sequence and a reading of the shading data can be recorded at each particular location or point desired to be tracked for motion capture. The shading data is then stored with reference to the position and orientation of the subject. In particular, the reference to orientation will include the direction perpendicular to surface of the subject at a particular point or location. In other embodiments, the subject can be configured into a few key positions and orientations and shading data readings can be taken for all locations for points of interest. The shading data is then stored with reference to the key position and orientations of the subject. Shading data readings can then be interpolated for positions and orientations located between the key positions and orientations.

In yet other embodiments, the correlation between shading data and surface normals on the surface of the subject can be determined by applying the correlation of shading data to surface normals of general geometric shapes. For example, correlations between the shading and surface normals of spheres, rectangular prisms and arbitrary spline surfaces can be determined and stored as geometric shape profiles. The geometric shape profiles can be determined with either direct shading data measurement of a sample subject, or they can be modeled in software. The geometric shape profiles can then be applied to all or portions of a region of interest on a subject so as to treat the surface of the subject as a composite of generic geometric shapes with a corresponding composite of correlations of shading to surface normals. In various embodiments, the composite of geometric shape profiles can be done dynamically by an operator or computer software.

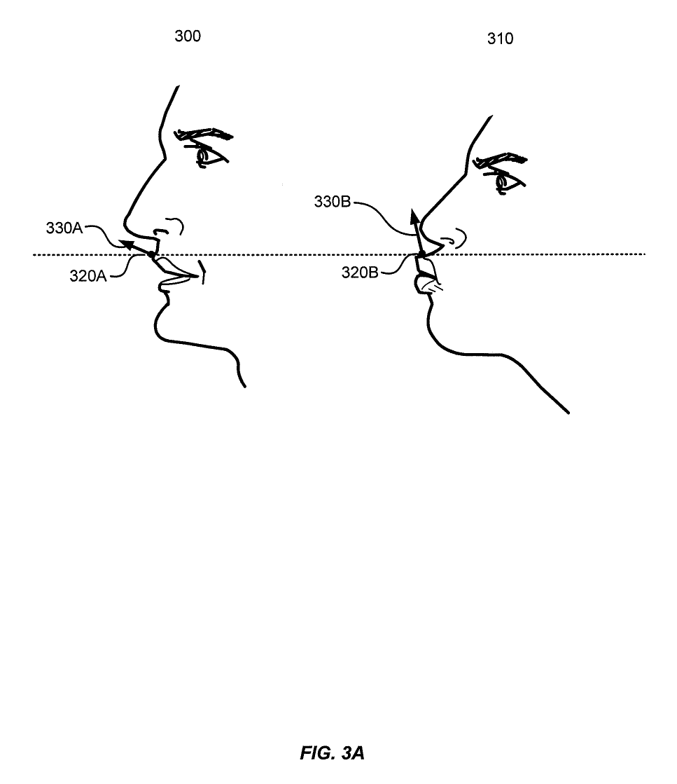

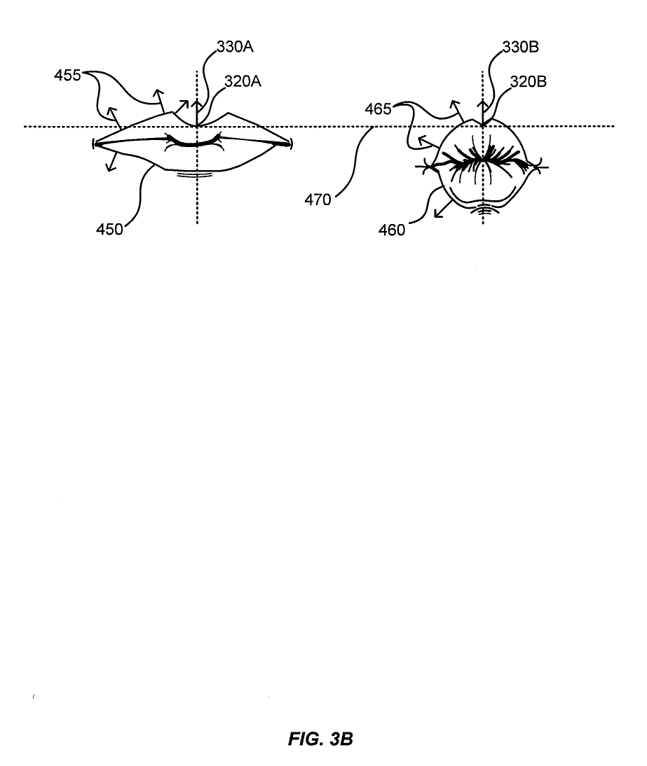

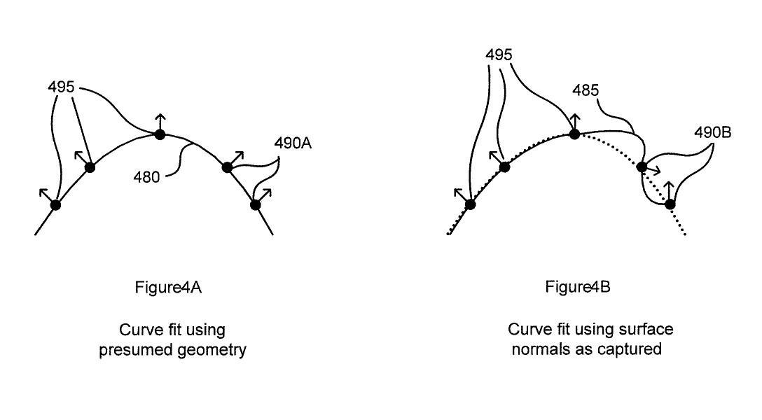

In step 270, images are rendered in response to the captured location of a plurality of points on the subject and direction normal to surface of the subject at those points. In various embodiments, possible changes to the surface In various embodiments, images are rendered using both the three-dimensional position of the points on the subject and the direction normal to the surface of the subject at those points. Using both the three-dimensional position and the direction normal to the surface, line and curve fitting algorithms can be constrained to more accurately render representations of the performance or changes of the subject. This step is discussed in more detail in reference to FIGS. 3A, 3B and 4 below.

In some embodiments, the a method for rendering images based on performance data of a subject according to one embodiment of the present invention stops at step 270 and it is not necessary or desirable to store or retrieve images. For example, in real time rendering scenarios, such as video or computer games, it might not be practical or desirable to store the images or record the action of the characters or objects being rendered in response to continual user input. In such embodiments, rendering the image is the end of the method.

In other embodiments, it is desirable to save or store the rendered images from step 270. In step 280, the images rendered in step 270 can be stored on a tangible medium. In various embodiments, the tangible medium is a computer memory such as a conventional hard drive, RAM or solid state hard drive. In various other embodiments, the tangible medium is portable medium such as an optical disk, a magnetic disk, a flash drive or other such device. In various embodiments, the tangible medium is contained in a remote server.

In step 290, rendered images are retrieved from the tangible medium and displayed on an output device. In various embodiments, the output device is a computer monitor or television screen. In various other embodiments, the output device is printer or plotter. In various other devices, the output device is a portable media player.

FIG. 3A is an illustration of a scenario where embodiments of the present invention can improve rendering of images based on the performance data of a human subject. This is just one example of a scenario that can be improved by the embodiments of the present invention and is no way intended to limit the application of the present invention. In this example, pose 300 of a subject includes point 320A of the subject's upper lip at one particular point in space at one particular point in time with the direction normal to the surface of the subject's lips at point 320A indicated by surface normal 330A. At another particular point in time, point 320A, has not moved in space as depicted in pose 310. The actual location of point 320B is the same as 320A on the subjects face. In addition it is contemplated that point 320A and 320B are in substantially the same location in space, however, the orientation of the surface of surface containing point 320B has changed dramatically. Going from the relaxed mouth position in pose 300 to the puckered or pursed mouth position in pose 310, the subjects has made substantial changes to the surface of the subject's face without actually changing spatial location. The differences between poses 300 and 310 can be easily seen by the change in the directions normal to the surface at point 320A and B. Surface normal 330A is at a different angle than surface normal 330B. Accordingly, the illumination, and hence the shading, from a stationary illumination source at point 320B in pose 310 will be different than that at 320A in pose 300. Using the correlation data between the shading and the position of the point of interest on the subject relative to the image capturing device and the illumination source, the direction normal to the surface of the subject can be determined according to various embodiments of the present invention. In various embodiments, the direction of the surface normal to the surface of the subject at a point and the position of the point in space are used to better fit a line or surface to multiple points to render a more accurate or realistic representation of the subject.

In various embodiments, the advantages provided by the present invention are further illustrated in FIG. 3B. FIG. 3B is detail view of the subject's lips as viewed from in front of the subject depicted in FIG. 3A. As seen in FIG. 3B, surface normals 330A and 330B originate at points on the surface of the subject at points 320A and 320B, respectively. As shown in FIG. 3B, point 320A can be in one location at a first time in pose 450, and then be in the same location at a second time as indicated by point 320B in pose 460 but have a completely different surface orientation of the lips. In FIG. 3B, it is clear that surface normals 455 and 465, even if they originate at the same points on the surface of the subject, that the points 455 have moved in the space and the surface normals have also change as represented by surface normals 465. What is difficult to see in FIG. 3B is that surface normals 455 and 465 have directional component that extends into or out of the page. In various embodiments, the information regarding the direction of the surface normals, based on the shading data contained in the performance data, is used to better render images of complex surfaces such as the lips depicted in FIGS. 3A and 3B.

In various embodiments, the performance data of a subject can be used to control a character, a model or other representation that is not necessarily intended to be a realistic representation of the subject. For example, using the performance data of a subject and the correlation shading data to surface normals, a computer generated cartoon character or other fictious animation can be programmed and animated to mimic the movements, gestures and facial expressions of a subject actor. In various embodiments, the performance data can include body movements, facial expressions or both. In various embodiments, the performance data can include shading data of a subject's body to include changes in the surface of the body due to muscle deformation.

FIG. 4A represents a curve fit using presumed geometry that can be improved by various embodiments of the present invention. As shown in FIG. 4A, points 495A and 490A each have an associated presumed direction normal to the line 480 fitted to the arrangement of all the points observed. The presumed geometry can include assumptions about particular subject objects. For example, when the subject object is a human face, it can be presumed that the face is bilaterally symmetrical. Therefore, it can be assumed that points on the face on opposite sides of the line of symmetry will have surface normals that mirror one another. Another example of a presumed geometry involves subject objects that only have planar surfaces. In such a scenario, it can be useful to presume that all points on a particular surface will have parallel surface normals and there will be abrupt discontinuities in the direction of the surface normals at the boundaries of the surfaces that make of the composite surface of the subject object.

As such, conventional curve fitting algorithms that presume some geometry do not take into account or ignore the actual direction normal to the surface of the subject at which the points are observed. In such cases, the curve 480 assumes that points can be fit to any curve based on some curve fitting algorithm or formula that imposes the direction normal to the curve. In contrast, various embodiments of the present invention based on performance data including shading data and relative location of points on the surface of a subject relative to illumination sources and image capturing devices can determine the direction normal to the surface of the subject and factor that into any curve or surface rendered in response the performance data of the subject.

FIG. 4B is an example of the difference between the curve fit to the points 495 and 490B and the curve fit to points 495 and 490A when using various embodiments of the present invention. As described above, the direction normal to a line or a surface of a subject is determined using performance data including shading data. In some cases, such as with points 495, the presumed direction normal to the curve may be the same as the direction determined by embodiments of the present invention. In such cases, it is likely that the curve or surface fit to the observed points is based on the natural or ordinary form that the observed subject's lines or surface would form. On the other hand, points 490B were determined to have directions normal to the different to the presumed directions of the 490A. As a result, curve 485 is significantly different from curve 480 because the direction normal to points 490B where taken into account fit the curve.

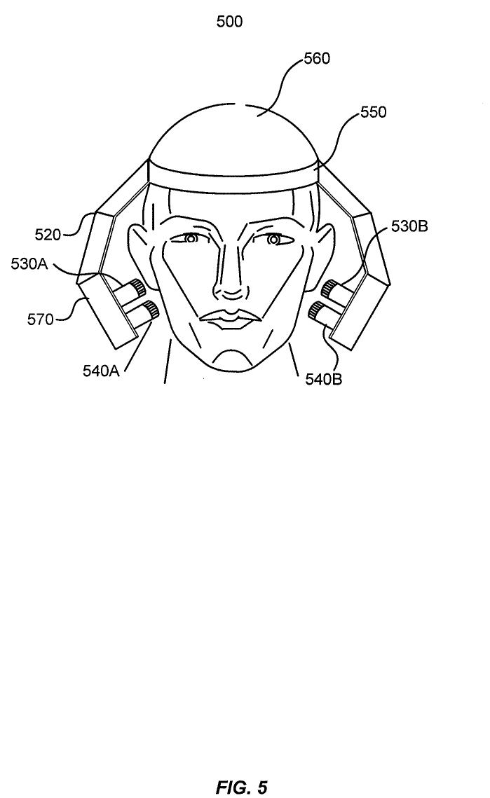

FIG. 5 is an illustration of a particular embodiment of the present invention used to capture facial performance data. Facial expression apparatus 500 comprises a head gear element 550 that sits securely and stably on the head of subject 560. Various embodiments of facial expression apparatus 500 are described in detailed in co-pending U.S. patent application Ser. No. 12/240,907 filed Sep. 29^{th}, 2008 and is incorporated herein by reference for all purposes.

In various embodiments, two arms 520A and B are rigidly attached to the head gear element 550 such then subject 560 moves his or her head, the arms remain stationary relative to the head of subject 560. In various embodiments arms 520A and B are adjustable so that the ends of the arms can be positioned above any part of the head of subject 560. In some embodiments, illumination sources 530A is fixed relative to image capturing device 540A and illumination source 530B is relative to image capturing device 540B. In other embodiments, the relative position of illumination source 530A and B to image capturing devices 540A and B are adjustable. In various embodiments, depending on the areas of interest on the head and face of subject 560, 1 to n arms can be used to capture performance data from various angles. An image-capturing device and an illumination source can be attached to each of the 1 to n arms.

Illumination sources 530A and B and image capturing devices 540A and B are attached to the end of arms 520A and B respectively. In various embodiments, illumination sources 530A and B emit light at the same wavelength. In various other embodiments, illumination sources emit light at different wavelengths. In various embodiments illumination sources 530A and B are point sources. In other embodiments, illumination sources 530A and B are uniform light sources within a constrained solid angle. One skilled in the art will realize that various types and illumination patterns or illumination sources can be used without deviating from the spirit of the present invention.

In various other embodiments, to avoid distracting or interfering with an actor's vision, illumination sources 530A and B emit light outside of the human visible spectrum. In providing illumination sources that emit light outside of the human visible spectrum, various wavelength bands and spectra can be configured for each application. In various embodiments, a matte surface applied to the surface of the subject can be specifically formulated to reflect preferentially the wavelength of the illumination sources. Alternatively, in some embodiments, an optical filter can be fitted to the image-capturing device to detect preferentially only the wavelength of the illumination source.

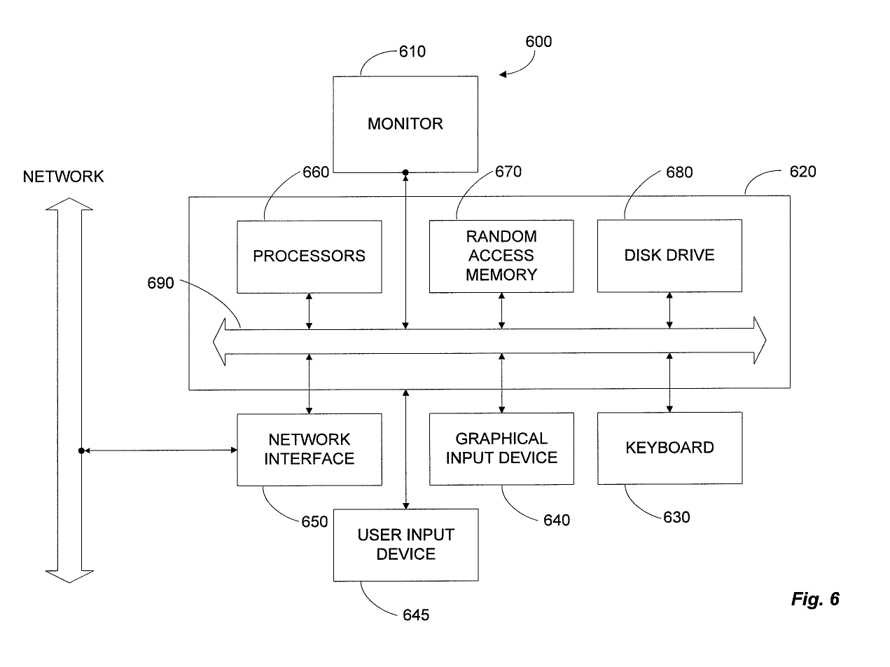

FIG. 6 is a block diagram of typical computer system 600 according to an embodiment of the present invention.

FIG. 6 is representative of a computer system capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other micro processors are contemplated, such as Xeon™, Pentium™ or Core™ microprocessors; Turion™ 64, Opteron™ or Athlon™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board. Various embodiments may be based upon systems provided by daVinci, Pandora, Silicon Color, or other vendors.

In the present embodiment, computer system 600 typically includes a display 610, computer 620, a keyboard 630, a user input device 640, computer interfaces 650, and the like. In various embodiments, display (monitor) 610 may be embodied as a CRT display, an LCD display, a plasma display, a direct-projection or rear-projection DLP, a microdisplay, or the like. In various embodiments, display 610 may be used to display user interfaces and rendered images.

In various embodiments, user input device 640 is typically embodied as a computer mouse, a trackball, a track pad, a joystick, wireless remote, drawing tablet, voice command system, eye tracking system, and the like. User input device 640 typically allows a user to select objects, icons, text and the like that appear on the display 610 via a command such as a click of a button or the like. An additional specialized user input device 645 may also be provided in various embodiments. User input device 645 may include a number of image capturing devices or image capturing systems as described above. In some embodiments, user input device can be an electronic measuring device such and a laser or sonic based measuring system to determine the relative distances between components of the systems described herein. In other embodiments, user input device 645 include additional computer system displays (e.g. multiple monitors). Further user input device 645 may be implemented as one or more graphical user interfaces on such a display.

Embodiments of computer interfaces 650 typically include an Ethernet card, a modem (telephone, satellite, cable, ISDN), (asynchronous) digital subscriber line (DSL) unit, FireWire interface, USB interface, and the like. For example, computer interfaces 650 may be coupled to a computer network, to a FireWire bus, or the like. In other embodiments, computer interfaces 650 may be physically integrated on the motherboard of computer 620, may be a software program, such as soft DSL, or the like.

RAM 670 and disk drive 680 are examples of computer-readable tangible media configured to store data such as captured and rendered image files, ordered geometric descriptions of objects, procedural descriptions of models, scene descriptor files, a rendering engine, embodiments of the present invention, including executable computer code, human readable code, or the like. Other types of tangible media include magnetic storage media such as floppy disks, networked hard disks, or removable hard disks; optical storage media such as CD-ROMS, DVDs, holographic memories, or bar codes; semiconductor media such as flash memories, read-only-memories (ROMS); battery-backed volatile memories; networked storage devices, and the like.

In the present embodiment, computer system 600 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiments of the present invention, a graphical processor unit, GPU, may be used to accelerate various operations, described below. Such operations may include color grading, automatically performing a gamut remapping, or the like.

In various embodiments, computer 620 typically includes familiar computer components such as a processor 660, and memory storage devices, such as a random access memory (RAM) 670, disk drives 680, and system bus 690 interconnecting the above components.

In some embodiments, computer 620 includes one or more Xeon microprocessors from Intel. Further, in the present embodiment, computer 620 typically includes a UNIX-based operating system.

The specification and drawings are, accordingly, to be regarded in an illustrative rather that a restrictive sense. It will, however, be evident that various modifications and changes may be made thereunto without departing from the broader spirit and scope of the invention as set forth in the claims.

What is claimed is:

1. A method for determining geometric shape data associated with a surface of an object comprising:
determining geometric reference data associated with an image capturing system comprising an image capturing device and an illumination source, wherein the image capturing device is configured to capture surface illumination of subject objects;
determining correlation between surface illumination data to surface normal data associated with subject objects, in response to the geometric reference data and in response to surface illumination data of subject objects;
capturing a plurality of images comprising performance data associated with the object with the image capturing device for a plurality of performance frames;
determining a plurality of surface normal data associated with the surface of the object for a plurality of surface locations on the object, for image from the plurality of images, in response to the plurality of images and in response to the correlation between surface illumination data to the surface normal data; and
rendering a plurality of images in response to the plurality of surface normal data associated with the surface of the object.

2. The method of claim 1 further comprising applying a matte surface to a surface of the object.

3. The method of claim 2 wherein the object comprises an actor's face.

4. The method of claim 3 wherein the matte surface is in the form of make-up.

5. The method of claim 2 wherein the image capturing system comprises two or more cameras and two or more illumination sources.

6. The method of claim 5 wherein the two or more illumination sources are point sources.

7. The method of claim 5 wherein a wavelength of the illumination sources is beyond human-visible wavelength.

8. The method of claim 7 wherein the wavelength of the illumination sources is selected from a group consisting of: infrared and ultraviolet.

9. A system for determining geometric shape data associated with a surface of an object comprising:
an image capturing system comprising an image capturing device and an illumination source;
wherein the image capturing device is configured to capture surface illumination of the object, wherein geometric reference data associated with the image capturing system is known, and a correlation between surface illumination data to surface normal data associated with the object based on the geometric reference data and surface illumination data of the object is known;
a computer system in communication with the image capturing system.

10. The system of claim 9 wherein the image capturing device comprises two or more digital cameras.

11. The system of claim 10 wherein the illumination source comprises two or more light sources.

12. The system of claim 11 wherein in the wavelength of the illumination source is beyond the human visible wavelength.

13. The system of claim 12 wherein the object is an actor's face.

14. The system of claim 11 wherein the computer system is configured to render a plurality of images in response to the plurality of surface normal data associated with the surface of the object.

15. An apparatus for determining geometric shape data associated with a surface of an object comprising:
a head gear configured to be stably fixed to the object;
one or more arms attached to the head gear,
one or more image capturing systems comprising an image capturing device and an illumination source attached to one end of one or more of the arms;
wherein the image capturing device is configured to capture surface illumination of the object, wherein geometric reference data associated with the image capturing system is known, and a correlation between surface illumination data to surface normal data associated with the object based on the geometric reference data and surface illumination data of subject objects is known; and
a computer system in communication with the image capturing system.

16. The apparatus of claim 15 wherein one or more of the illuminations sources are point sources.

17. The apparatus of claim 15 wherein the wavelength of one or more of the illumination sources is beyond the human visible wavelength.

18. The apparatus of claim 17 wherein the object is a face.

19. The apparatus of claim 15 wherein the position of one or more of the arms on the head gear are adjustable.

20. The apparatus of claim 15 wherein the computer system is in communication with the image capturing system via a wireless link.
